(19) United States
(12) Patent Application Publication
(10) Pub. No.: US 2021/0065195 A1
(43) Pub. Date: Mar. 4, 2021

(54) CREDIT CARD TRANSACTION DEVICE AND METHOD FOR USING CREDIT CARD IN TRANSACTIONS

(71) Applicant: HONGFUJIN PRECISION ELECTRONICS(TIANJIN)CO.,LTD., Tianjin (CN)

(72) Inventors: SHIH CHUN WANG, New Taipei (TW); YU-WEN CHEN, New Taipei (TW); PO-CHENG CHEN, New Taipei (TW)

(21) Appl. No.: 16/713,364

(22) Filed: Dec. 13, 2019

(30) Foreign Application Priority Data
Aug. 28, 2019 (CN) 201910803295.9

(51) Int. Cl. G06Q 20/40; G06Q 20/34

(52) U.S. Cl. CPC G06Q 20/40145; G06Q 20/34; G06Q 20/4016

(57) ABSTRACT

A credit card transaction device fortified against fraudulent use includes a display screen and a processor. A method disclosed for the device and for a server in communication with the device includes obtaining basic information of a credit card and an image of a user; analyzing whether the image includes a face; extracting facial features from the image when the image includes the face; determining whether the facial features and the basic information are consistent with a basic information and facial features of a legitimate user which are stored. When the facial features and the basic information are consistent with the stored data, a password verification interface is provided and an entered password is verified with the stored password for consistency. The credit card transaction is performed when the entered password matches the stored password.

### FIELD

The subject matter herein generally relates to credit cards, especially to a credit card transaction device and a credit card transaction method.

### BACKGROUND

Many people have credit cards, and before use, a user is required to input a password. If the password is correct, the credit card can be used. However, the information of the credit card can be easily leaked or stolen. If the card number and password of the credit card are leaked or stolen, there is a possibility of fraudulent use and may result in financial losses to the credit card owner.

### BRIEF DESCRIPTION OF THE DRAWINGS

Implementations of the present technology will now be described, by way of embodiments, with reference to the attached figures.

FIG. 1 is a block diagram of a credit card transaction device, according to a first embodiment.

FIG. 2 is a block diagram of a server communicating with the credit card transaction device of FIG. 1.

FIG. 3 and FIG. 4 are a flowchart of a credit card transaction method, according to an embodiment.

FIG. 5, FIG. 6 and FIG. 7 are a flowchart of a credit card transaction method, according to another embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

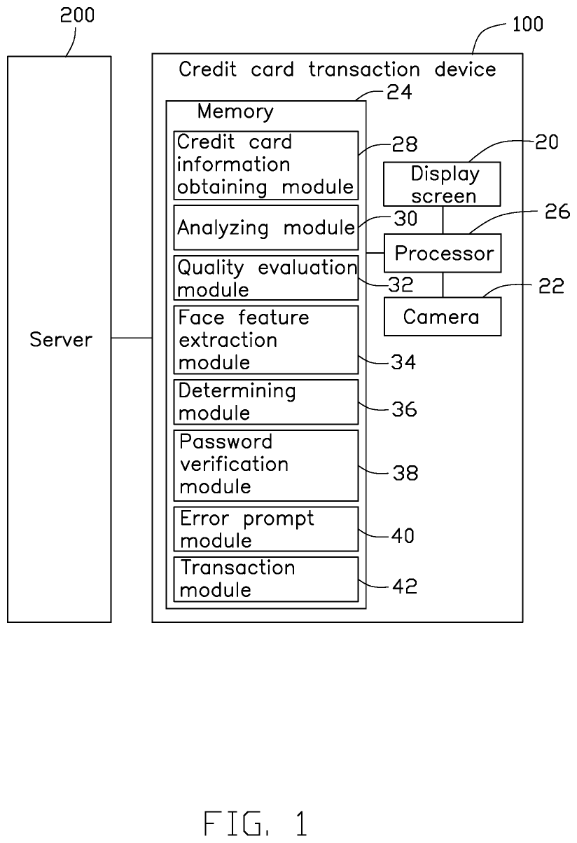

FIG. 1 illustrates a credit card transaction device 100. The credit card transaction device 100 can be an electronic device such as a computer, a tablet computer, a mobile phone, or a POS (Point of Sale) machine. The credit card transaction device 100 communicates with a server 200 when a user carries out a credit card transaction. The credit card transaction device 100 includes a display screen 20, a camera 22, a memory 24, and a processor 26. The memory 24 is used to store various types of data of the credit card transaction device 100. The memory 24 stores a credit card information obtaining module 28, an analyzing module 30, a quality evaluation module 32, a face feature extraction module 34, a determining module 36, a password verification module 38, an error prompt module 40, and a transaction module 42. The processor 26 is configured to calculate and process various types of data of the credit card transaction device 100.

The credit card information obtaining module 28 obtains basic information of a useable and pre-used credit card. The basic information includes at least information such as a credit card number, a username, and an expiration date. In an embodiment, the credit card information obtaining module 28 acquires basic information of the credit card by extracting basic information of the credit card input on a credit card information input interface displayed on the display screen 20. The basic information of the credit card can be input through a virtual touch keyboard displayed on the display screen 20.

The camera 22 is used to capture an image of a user. It should be understood that the camera 22 can be independent of the credit card transaction device 100, and the camera 22 communicates with the credit card transaction device 100 and transmits the captured images to the credit card transaction device 100.

The analyzing module 30 is configured to analyze whether there is a user face in the captured image. The quality evaluation module 32 is configured to evaluate whether image quality of the captured image conforms to a standard when there is a user face in the captured image. The image quality includes pixel size, brightness of the captured image, and sharpness of the features shown in the captured image. The face feature extraction module 34 extracts facial features of the user from the captured image when the image quality of the captured image conforms to the standard. The facial features include eyes, nose, mouth, and the like.

The server 200 stores basic information of at least one credit card, facial features of a legitimate user, and a password corresponding to each credit card. The determining module 36 is configured to determine whether the obtained facial features and the obtained basic information are consistent with the stored basic information of a credit card and the facial features of the legitimate user corresponding to the credit card. In an embodiment, the determining module 36 obtains the facial features of the legitimate user from the server 200 according to the basic information of the pre-used credit card, and determines whether the facial features of the legitimate user are consistent with the obtained facial features. In another embodiment, the determining module 36 obtains basic information of the credit card from the server 200 according to the obtained facial features of the user, and then determines whether the basic information of the credit card obtained from the server 200 is consistent with the basic information of the pre-used credit card.

The password verification module 38 is configured to provide a password verification interface for the user to enter a password. The password entered by the user must be verified as matching the payment password of the credit card when the obtained facial features and the obtained basic information are respectively consistent with the stored basic information of a credit card and the facial features corresponding to the credit card. The password may be a static password, such as a payment password set by the user when the credit card is first processed. The password may also be a dynamic password, such as a verification password sent to, but mot limited to, a mobile phone, a credit card pair, an e-mail or a password generator device, etc. associated with the credit card. The error prompt module 40 is configured to display an error message on the display screen 20 when any of the obtained facial features and the obtained basic information is not consistent with the stored basic information of a credit card and the facial features corresponding to the credit card.

The transaction module 42 is configured to perform a transaction by the user when the password input by the user matches the stored payment password of the credit card. A transaction action is rejected when the password input by the user does not match the stored payment password of the credit card.

It can be understood that the memory 24 may be placed in a remote device communicating with the credit card transaction device 100 instead of being placed in the credit card transaction device 100.

In another embodiment, the memory 24 does not include the password verification module 38 described above, but includes another transaction module and a signature verification module, and the other transaction module is configured to perform a transaction action when the obtained facial feature and the obtained basic information are respectively consistent with the stored basic information of a credit card and the facial features corresponding to the credit card. The signature verification module is configured to perform user signature authentication when the transaction action is completed. The user signature authentication process is similar to that in the prior art, and is not described herein.

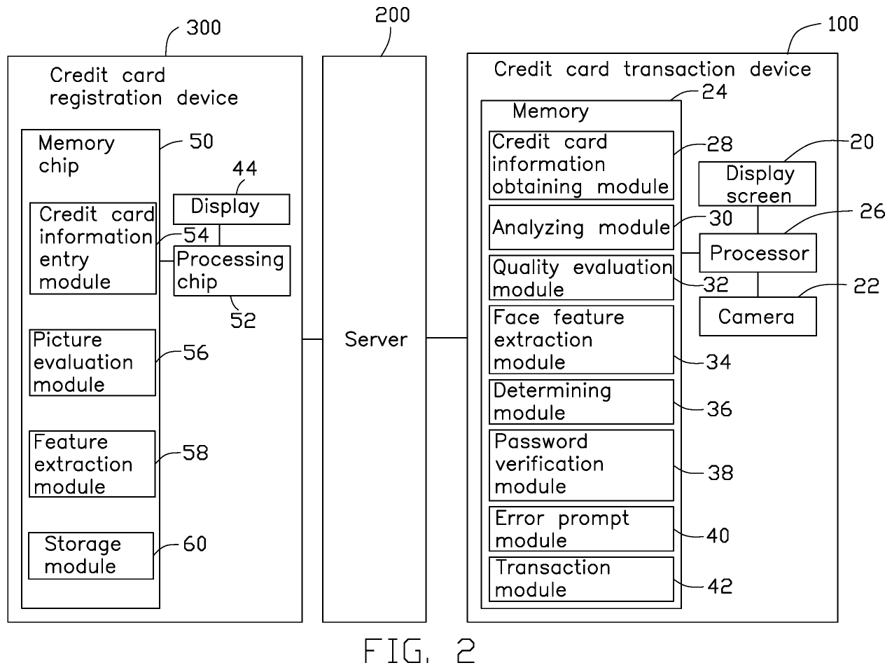

Referring to FIG. 2, in another embodiment, the server 200 communicates with the credit card transaction device 100 and a credit card registration device 300. The credit card registration device 300 is configured to register a credit card for the user and can store the basic information of the registered credit card, the facial features of the legitimate user, and the payment password. The basic information storage can also be in the server 200.

The credit card registration device 300 includes a display 44, a memory chip 50, and a processing chip 52. The memory chip 50 is used to store various types of data of the credit card registration device 300. The memory chip 50 stores a credit card information entry module 54, a picture evaluation module 56, a feature extraction module 58, and a storage module 60. The processing chip 52 is used to calculate and process various types of data of the credit card registration device 300.

The credit card information entry module 54 provides a credit card information entry interface on the display 44. The credit card information entry interface is used to enter the payment password of the credit card and the picture of the legitimate user of the credit card. The picture of the legitimate user includes the face of the legitimate user. The picture evaluation module 56 is configured to evaluate whether the image quality of the picture of the legitimate user meets the standard. The image quality includes pixel size, brightness of the picture, sharpness of the objects in the picture, and the like. The feature extraction module 58 is configured to extract the facial features of the legitimate user from the picture of the legitimate user when the image quality of the picture of the legitimate user meets the standard. The facial features include eyes, nose, mouth, and the like. The storage module 60 is configured to store the basic information of the register credit card, the payment password of the registered credit card, and the facial features of the legitimate user of the registered credit card to the server 200.

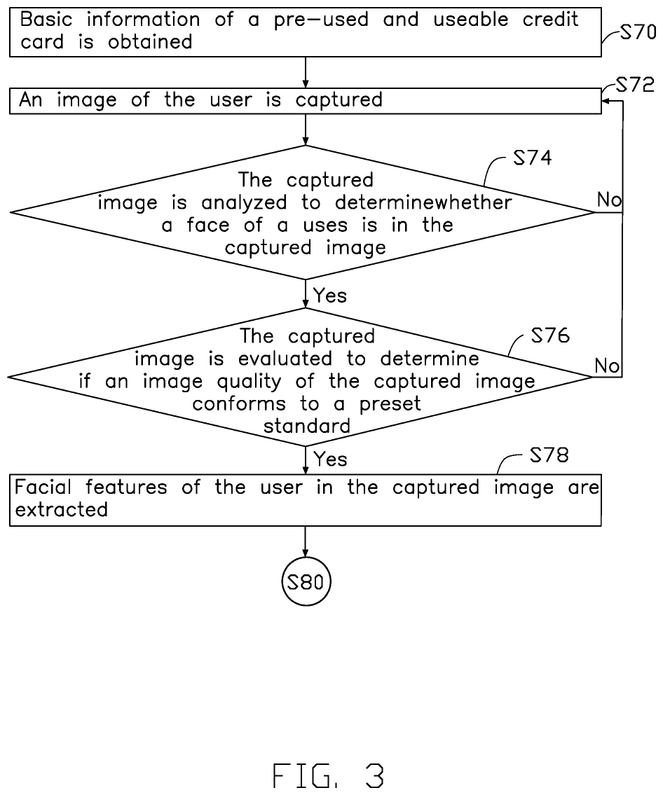

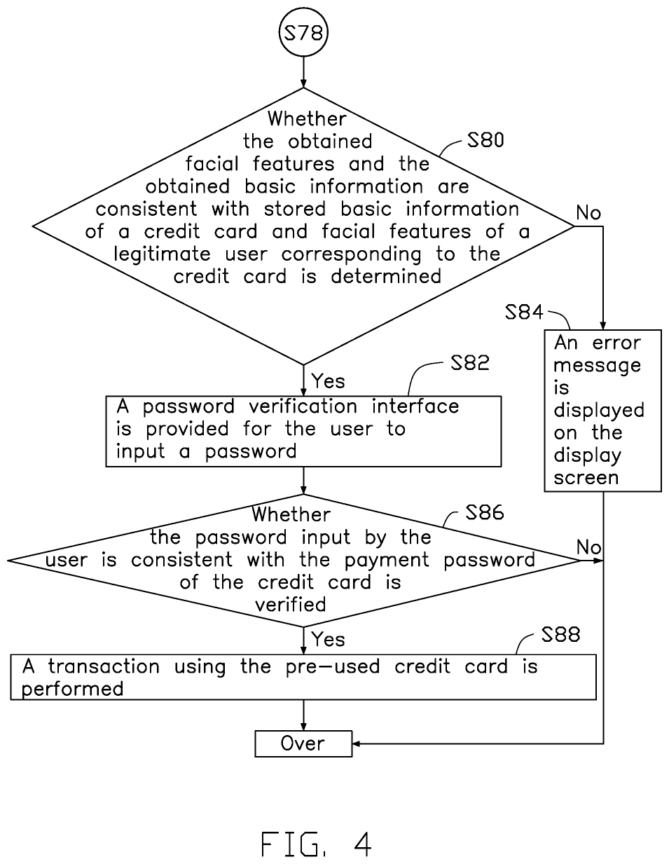

FIGS. 3 and 4 illustrate a flowchart of a credit card transaction method. The method is provided by way of example, as there are a variety of ways to carry out the method. Each block shown in FIGS. 3 and 4 represents one or more processes, methods, or subroutines, carried out in the exemplary method. Additionally, the illustrated order of blocks is by example only and the order of the blocks can be changed according to the present disclosure. The method can begin at block S70. Depending on the embodiment, additional steps can be added, others removed, and the ordering of the steps can be changed.

At block S70, basic information of a pre-used and useable credit card is obtained. In an embodiment, the basic information of the pre-used credit card is obtained by extracting basic information of the credit card input into a pre-used credit card information input interface displayed on a display screen.

At block S72, an image of the user is captured.

At block S74, the captured image is analyzed to determine whether a face of a uses is in the captured image. If there is a user face in the captured image, the procedure proceeds to block S76, otherwise, the procedure remains at block S72.

At block S76, the captured image is evaluated to determine if an image quality of the captured image conforms to a preset standard. The image quality includes pixel size, brightness of the captured image, sharpness of the objects in the captured image, and the like. If the image quality of the user face conforms to the standard, the procedure proceeds to block S78, otherwise, the procedure proceeds to block S72.

At block S78, facial features of the user in the captured image are extracted. The facial features include eyes, nose, mouth, and the like.

At block S80, whether the obtained facial features and the obtained basic information are consistent with stored basic information of a credit card and facial features of a legitimate user corresponding to the credit card is determined. If the obtained facial features and the obtained basic information are respectively consistent with the stored basic information of a credit card and the facial features corresponding to the credit card, the procedure proceeds to block S82, otherwise, the procedure proceeds to block S84.

In an embodiment, block S80 includes obtaining the facial features of the legitimate user from the stored data according to the basic information of the credit card, and determining whether the facial features of the legitimate user are consistent with the obtained facial features. In another embodiment, block S80 includes obtaining basic information of the corresponding credit card from the stored data according to the obtained facial features of the user, and then whether the basic information of the credit card obtained from the stored data is consistent with the basic information of the pre-used credit card is determined.

At block S82, a password verification interface is provided for the user to input a password. The password may be a static password, such as a payment password set by the user when the credit card is first processed; the password may also be a dynamic password, such as a verification password sent to a mobile phone number associated with the credit card.

At block S84, an error message is displayed on the display screen 20.

At block S86, whether the password input by the user is consistent with the payment password of the credit card is verified. If the password input by the user is consistent with the payment password of the credit card, the procedure proceeds to block S88, otherwise, the procedure ends.

At block S88, a transaction using the pre-used credit card is performed.

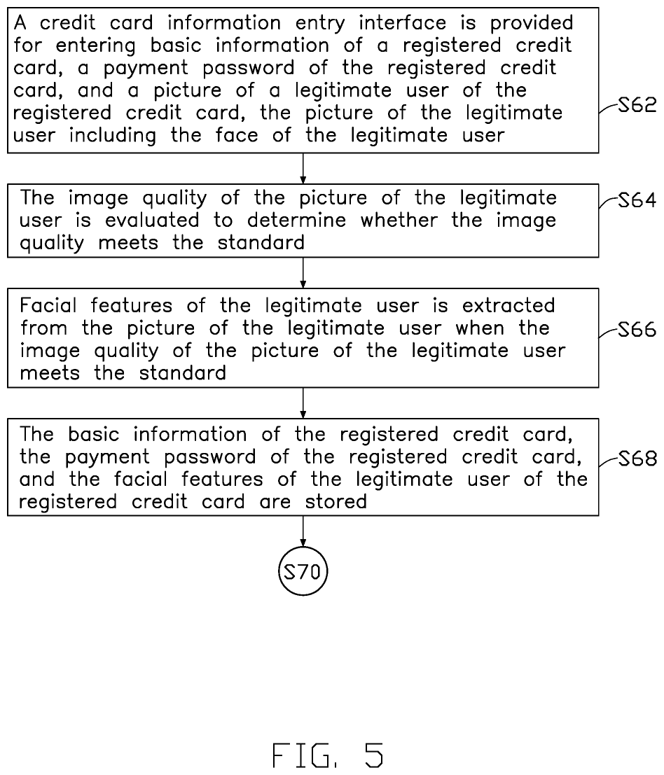

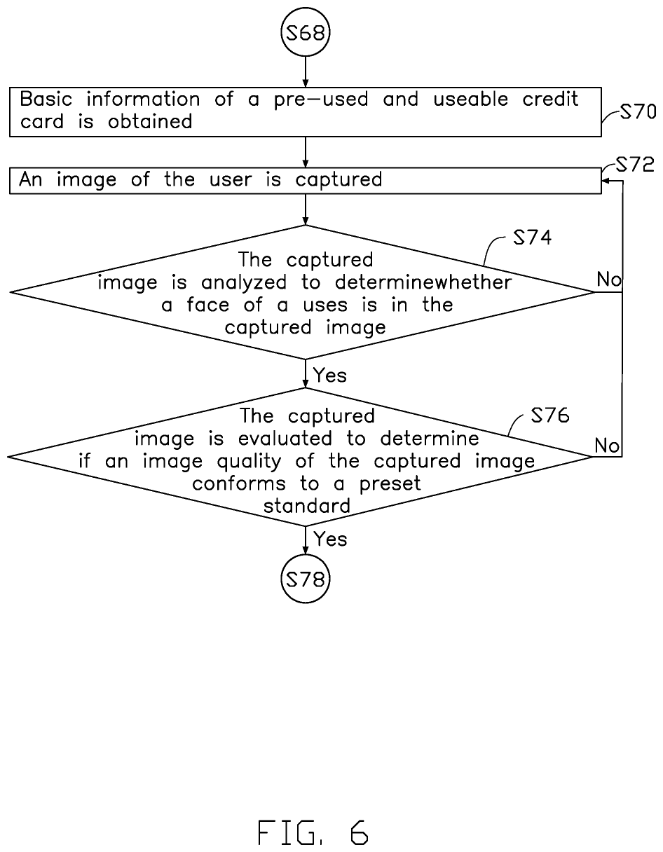

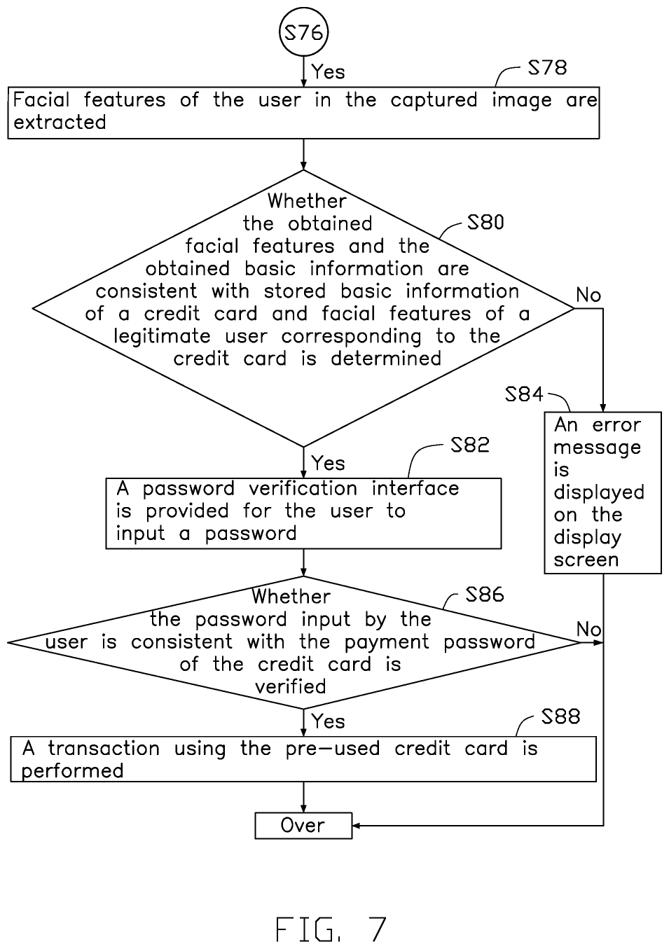

FIGS. 5-7 illustrate another embodiment of a credit card transaction method, the embodiment further including block S62 to block S68.

At block S62, a credit card information entry interface is provided for entering basic information of a registered credit card, a payment password of the registered credit card, and a picture of a legitimate user of the registered credit card, the picture of the legitimate user including the face of the legitimate user.

At block S64, the image quality of the picture of the legitimate user is evaluated to determine whether the image quality meets the standard.

At block S66, facial features of the legitimate user is extracted from the picture of the legitimate user when the image quality of the picture of the legitimate user meets the standard.

At block S68, the basic information of the registered credit card, the payment password of the registered credit card, and the facial features of the legitimate user of the registered credit card are stored.

In another embodiment, a credit card transaction method does not include the block S82 and the block S86, and when the obtained facial features and the obtained basic information are respectively consistent with the stored basic information of a credit card and the facial features corresponding to the credit card, the procedure proceeds to block S88. This method further comprises performing user signature authentication after block S88.

The embodiments shown and described above are only examples. Even though numerous dataistics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A credit card transaction device comprising:
a display screen;
a memory that stores one or more programs; and
at least one processor, wherein the one or more programs, when executed by the at least one processor, cause the at least one processor to:
obtain basic information of a pre-used credit card;
capture an image of a user;
analyze the image captured whether a face of the user is in the image;
extract facial features of the face from the captured image if the face of the user is in the image;
determine whether the extracted facial features and the obtained basic information of the pre-used credit card are consistent with stored basic information of a credit card and facial features of a legitimate user corresponding to the stored credit card;
provide a password verification interface for the user to input a password and verify whether the password input by the user is consistent with a payment password of the credit card; and
authorize a transaction action with the pre-used credit card if the password input by the user is consistent with the stored payment password of the credit card.

2. The credit card transaction device as claimed in claim 1, wherein the at least one processor is further caused to:
display an error message on the display screen if any of the obtained facial features and the obtained basic information is not consistent with the stored basic information of the credit card and the facial features of the legitimate user.

3. The credit card transaction device as claimed in claim 1, wherein the at least one processor is further caused to:
evaluate the captured image to determine whether an image quality of the captured image conforms to a standard; and
extract facial features of the user from the captured image if a face of a user is in the captured image if the image quality of the captured image conforms to the standard.

4. The credit card transaction device as claimed in claim 3, wherein the image quality comprises a pixel size, a brightness of the captured image, and a sharpness of the captured image.

5. The credit card transaction device as claimed in claim 3, wherein the basic information of the pre-used credit card is obtained by extracting the basic information of the pre-used credit card input on a credit card information input interface displayed on the display screen.

6. The credit card transaction device as claimed in claim 1, wherein the credit card transaction device is communicatable to a server, the server stores basic information of at least one credit card, facial features of the legitimate user, and a payment password corresponding to each of the least one credit card.

7. The credit card transaction device as claimed in claim 1, wherein the password is dynamic, the password is a verification password sent to a mobile phone, a credit card pair, an e-mail or a password generator device associated with the credit card.

8. The credit card transaction device as claimed in claim 1, wherein the facial features comprise eyes, nose, and mouth.

9. A credit card transaction method comprising:
obtaining basic information of a pre-used credit card;
capturing an image of a user;
analyzing the image captured whether a face of the user is in the image;
extracting facial features of the face from the captured image if the face of the user is in the image;
determining whether the extracted facial features and the obtained basic information of the pre-used credit card are consistent with stored basic information of a credit card and facial features of a legitimate user corresponding to the stored credit card;
providing a password verification interface for the user to input a password and verifying whether the password input by the user is consistent with a payment password of the credit card; and
authorize a transaction action with the pre-used credit card if the password input by the user is consistent with the stored payment password of the credit card.

10. The credit card transaction method as claimed in claim 9, further comprising:
displaying an error message on the display screen if any of the obtained facial features and the obtained basic information is not consistent with the stored basic information of the credit card and the facial features of the legitimate user.

11. The credit card transaction method as claimed in claim 9, further comprising:
evaluating the captured image to determine whether an image quality of the captured image conforms to a standard; and
extracting facial features of the user from the captured image if a face of a user is in the captured image if the image quality of the captured image conforms to the standard.

12. The credit card transaction method as claimed in claim 11, wherein the image quality comprises a pixel size, a brightness of the captured image, and a sharpness of the captured image.

13. The credit card transaction method as claimed in claim 11, wherein the basic information of the pre-used credit card is obtained by extracting the basic information of the pre-used credit card input on a credit card information input interface displayed on the display screen.

14. The credit card transaction method as claimed in claim 9, wherein the password is dynamic, the password is a verification password sent to a mobile phone number associated with the credit card.

15. The credit card transaction method as claimed in claim 9, wherein the facial features comprise eyes, nose, and mouth.

16. The credit card transaction method as claimed in claim 9, further comprising:
providing a credit card information entry interface for entering basic information of a registered credit card, a payment password of the registered credit card, and a picture of a legitimate user of the registered credit card, the picture of the legitimate user comprising the face of the legitimate user;
evaluating whether the image quality of the picture of the legitimate user meets the standard;
extracting facial features of the legitimate user from the picture of the legitimate user when the image quality of the picture of the legitimate user meets the standard; and
storing the basic information of the registered credit card, the payment password of the registered credit card, and the facial features of the legitimate user of the registered credit card.
